(19) United States
(12) Patent Application Publication
(10) Pub. No.: US 2009/0289894 A1
(43) Pub. Date: Nov. 26, 2009

(54) ELECTRONIC APPARATUS AND THREE-DIMENSIONAL INPUT DEVICE THEREOF

(75) Inventor: Jung-Chi LAI, Taoyuan County (TW)

Correspondence Address: QUINTERO LAW OFFICE, PC, 2210 MAIN STREET, SUITE 200, SANTA MONICA, CA, 90405, US

(73) Assignee: DARFON ELECTRONICS CORP., Taoyuan (TW)

(21) Appl. No.: 12/472,038

(22) Filed: May 26, 2009

(30) Foreign Application Priority Data
May 26, 2008 (TW) TW97119334

(51) Int. Cl. G09G 5/00

(52) U.S. Cl. 345/156

(57) ABSTRACT

An electronic apparatus and a three-dimensional input device thereof are disclosed. The electronic apparatus includes a display and the three-dimensional input device. The three-dimensional input device includes an infrared ray emitting/receiving unit, a cursor control unit and a radio frequency receiving unit. The infrared ray emitting/receiving unit is electrically connected to the display and includes an infrared ray emitter and an infrared ray receiver. The cursor control unit includes a reflective material and a radio frequency emitter. The radio frequency emitter is electrically connected to the display.

### CROSS REFERENCE TO RELATED APPLICATIONS

This Application claims priority of Taiwan Patent Application No. 097119334, filed on May 26, 2008, the entirety of which is incorporated by reference herein.

### BACKGROUND OF THE INVENTION

1. Field of the Invention

The present invention relates to an electronic apparatus and a three-dimensional input device thereof, and more particularly to an electronic apparatus and a three-dimensional input device thereof utilizing an infrared ray to judge a coordinate transition.

2. Description of the Related Art

A conventional three-dimensional input device utilizes a gyroscope for achieving the three-dimensional input result. When the three-dimensional input device is moved, the gyroscope transmits different electronic signals via the change of the accelerated velocity and the angle for judging the coordinate transition of the three-dimensional input device.

Another conventional three-dimensional input device comprises an infrared ray sensor. An infrared ray emitter emits an infrared ray. When the three-dimensional input device is moved, the infrared ray sensor of the three-dimensional input device obtains the coordinate transition and then transmits different electronic signals for judging the coordinate transition.

### BRIEF SUMMARY OF THE INVENTION

The present invention provides an electronic apparatus and a three-dimensional input device thereof. The electronic apparatus comprises a display and the three-dimensional input device. The three-dimensional input device comprises an infrared ray emitting/receiving unit, a cursor control unit and a radio frequency receiving unit. The infrared ray emitting/receiving unit electrically connects to the display and comprises an infrared ray emitter and an infrared ray receiver. The cursor control unit comprises a reflective material and a radio frequency emitter. The radio frequency receiving unit is electrically connected to the display. The reflective material reflects infrared ray signals emitted by the infrared ray emitter. The infrared ray signals are reflected to the infrared ray receiver, and the infrared ray receiver transmits the infrared ray signals to the electric display. The radio frequency emitter emits radio frequency signals to the radio frequency receiving unit, and the radio frequency signals are transmitted to the electronic apparatus by the radio frequency receiving unit.

Note that the cursor control unit further comprises a function key, and when the function key is pressed, the radio frequency emitter emits the radio frequency signals for controlling an output image.

Note that when simultaneously pressing the function key and moving the cursor control unit rightward and leftward, the output image is moved rightward and leftward.

Note that when simultaneously pressing the function key and moving the cursor control unit upward and downward, the output image is moved upward and downward.

Note that when simultaneously pressing the function key and moving the cursor control unit forward and backward, the output image is enlarged and reduced.

Note that when simultaneously pressing the function key and moving the cursor control clockwise, the output image is fast-forwarded.

Note that when simultaneously pressing the function key and moving the cursor control anticlockwise, the output image is rewinded.

Note that the cursor control unit further comprises a menu key, and when the menu key is pressed, the radio frequency emitter emits the radio frequency signals to the radio frequency receiving unit for controlling a menu image of a program of the output image or a menu image of a quick-link.

### BRIEF DESCRIPTION OF THE DRAWINGS

The present invention can be more fully understood by reading the subsequent detailed description and examples with references made to the accompanying drawings, wherein:

FIG. 1 is a schematic view showing an electronic apparatus and a three-dimensional input device thereof of the invention;

FIG. 2 is a flow chart view of an electronic apparatus; and

FIG. 3 is a schematic view of a menu of a program or a quick-link.

These and other objectives of the present invention will become obvious to those of ordinary skill in the art after reading the following detailed description of the preferred embodiments that are illustrated in the various figures and drawings.

### DETAILED DESCRIPTION OF THE INVENTION

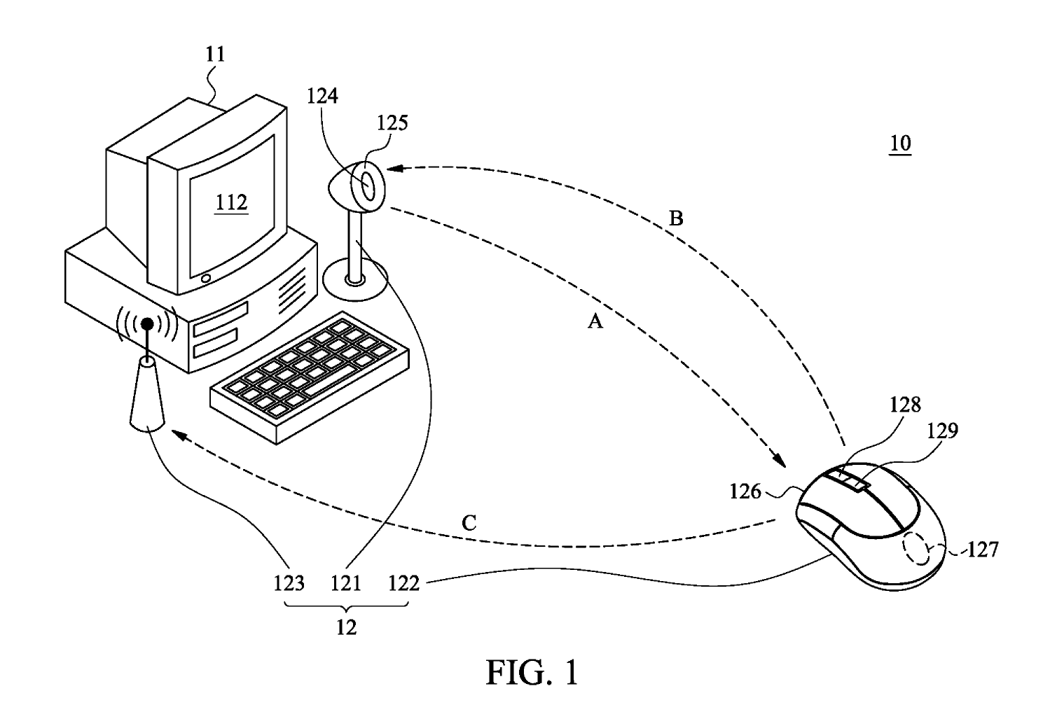

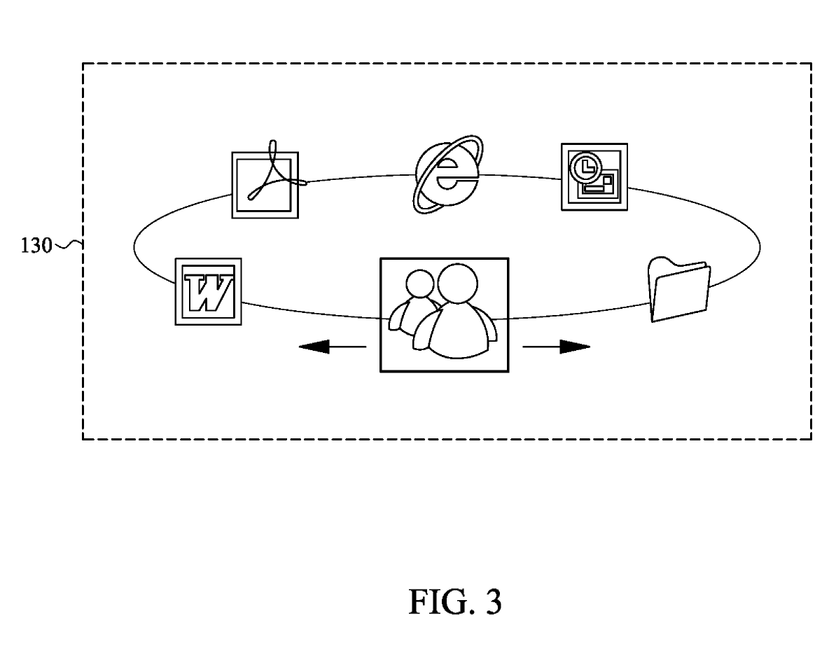

FIG. 1 is a schematic view showing an electronic apparatus and a three-dimensional input device thereof of the invention. Referring to FIG. 1, the electronic apparatus 10 comprises a display 11 and a three-dimensional input device 12. In this embodiment, the three-dimensional input device 12 is a mouse. The display 11 displays an output image. The three-dimensional input device 12 comprises an infrared ray emitting/receiving unit 121, a cursor control unit 122 and a radio frequency receiving unit 123. The infrared ray emitting/receiving unit 121 is electrically connected to the display 11 and comprises an infrared ray emitter 124 and an infrared ray receiver 125. In this embodiment, the infrared ray emitter 124 is disposed in the center of the infrared ray emitting/receiving unit 121. The infrared ray receiver 125 surrounds the outer portion of the infrared ray emitter 124. The cursor control unit 122 comprises a reflective material 126 and a radio frequency emitter 127, a function key 128, and a menu key 129. The reflective material 126 reflects infrared ray signals emitted by the infrared ray emitter 124, and the reflected infrared rays are transmitted to the infrared ray receiver 125, shown as arrows A and B. In this embodiment, the reflective material 126 is disposed on the front end of the mouse for reflecting the infrared ray. The function key 128 and the menu key 129 are adjacently disposed. When the function key is pressed 128, the radio frequency emitter 127 emits the radio frequency signals to the radio frequency receiving unit 123 (shown as arrow C). The radio frequency signals control an output image 112. When the menu key 129 is pressed, the radio frequency emitter 127 emits the radio frequency signals to the radio frequency receiving unit 123. The radio frequency signals control a program of the output image or a menu 130 of a quick-link (refer to FIG. 3). The radio frequency receiving unit 123 is electrically connected to the display 11.

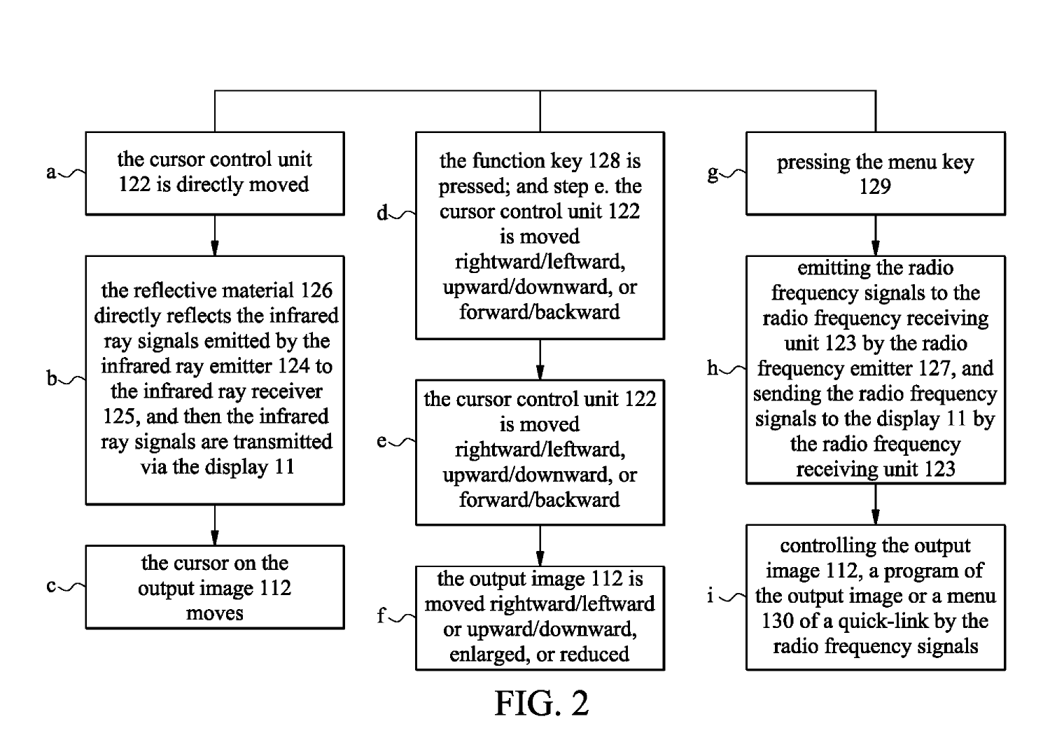

Referring to FIGS. 1, 2 and 3, FIG. 2 is a flow chart view of an electronic apparatus and FIG. 3 is a schematic view of a menu of a program or a quick-link. When a user hopes to move the cursor on the output image 112 via the three-dimensional input device 12, the steps involved in the process comprises the steps of: step a. the cursor control unit 122 is directly moved; step b. the reflective material 126 directly reflects the infrared ray signals emitted by the infrared ray emitter 124 to the infrared ray receiver 125, and then the infrared ray signals are transmitted via the display 11; and step c. the cursor on the output image 112 moves.

When the output image 11 of the display 11 needs to be moved rightward/leftward, upward/downward, or enlarged/reduced, the steps involved in the process comprise the steps of: step d. the function key 128 is pressed; and step e. the cursor control unit 122 is moved rightward/leftward, upward/downward, or forward/backward. In this embodiment, the display is set so that when the cursor control unit 122 is moved rightward or leftward, the output image 112 is moved rightward or leftward after pressing the function key 128. Other settings comprise: after pressing the function key 128, moving the cursor control unit 122 upward or downward makes the output image 112 move upward or downward; and when the function key is pressed 128, moving the cursor control unit 122 forward or backward makes the output image 112 enlarged or reduced. Thus, in continuation, for the step f, the output image 112 is moved rightward/leftward or upward/downward, enlarged, or reduced. In this embodiment, if the output image is a video, after pressing the function key and performing a clockwise circling movement via the cursor control unit 122, the video is fast-forwarded. On the contrary, a counter clockwise circling movement via the cursor control unit 122 makes the video rewind.

In this embodiment, when the function key is pressed 128 and simultaneously the cursor control unit 122 is simultaneously moved rightward/leftward, upward/downward, or forward/backward, the output image 112 is moved rightward/leftward/upward/downward, enlarged, or reduced. When releasing the function key 128 and simultaneously moving the cursor control unit 122 in three dimensions, the cursor on the output image 112 is moved corresponding to the cursor control unit 122. In this embodiment, the invention may adopt another control method. That is, when the function key 128 is pressed a first time, moving the cursor control unit 122 rightward/leftward, upward/downward, or forward/backward makes the output image 112 move rightward/leftward or upward/downward, enlarged, or reduced. Thus, the corresponding control type function is started. When the function key is pressed 128 again and the cursor control unit 122 is simultaneously moved in three dimensions, only the cursor on the output image 112 is moved, and the corresponding control type function is closed.

The three-dimensional input device of the invention provides a menu image of a program or a quick-link. Other steps involved in the process comprise the steps of: step g. pressing the menu key 129; step h. emitting the radio frequency signals to the radio frequency receiving unit 123 by the radio frequency emitter 127, and sending the radio frequency signals to the display 11 by the radio frequency receiving unit 123; and step i. controlling the output image 112, a program of the output image or a menu 130 of a quick-link by the radio frequency signals (as shown in FIG. 3).

In summary, the infrared ray emitting/receiving unit 121 and the reflective material 126 are provided to detect the moving direction of the cursor control unit 122. After transforming signals to digital signals, the cursor of the output image 112 is controlled to be moved. The function key 128 collocating with the infrared ray emitting/receiving unit 121 and the reflective material 126 provide the corresponding control type function. That is, after pressing the function key 127 and simultaneously moving the cursor control unit 122 in three dimensions, the output image 112 is moved, enlarged, or reduced. When the output image 112 is a video, fast-forwarding and rewinding functions are provided. Finally, the menu 130, the radio frequency emitter 127, and the radio frequency receiving unit 123 provide the menu 130 of a program or of a quick-link. Thus, the electronic apparatus 10 and the cursor control unit 122 thereof provide an improved three-dimensional input function for easy control of the electronic apparatus 10.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A three-dimensional input device, controlling a display of an electronic apparatus, comprising:
an infrared ray emitting/receiving unit, electrically connected to the display and comprising an infrared ray emitter and an infrared ray receiver;
a cursor control unit, comprising a reflective material and a radio frequency emitter; and
a radio frequency receiving unit, electrically connected to the display,
wherein the reflective material reflects infrared ray signals emitted by the infrared ray emitter, the infrared ray signals are reflected to the infrared ray receiver, and the infrared ray receiver transmits the infrared ray signals to the electric apparatus; and
the radio frequency emitter emits radio frequency signals to the radio frequency receiving unit, and the radio frequency signals are transmitted to the electronic apparatus by the radio frequency receiving unit.

2. The three-dimensional input device as claimed in claim 1, wherein the cursor control unit further comprises a function key, and when the function key is pressed, the radio frequency emitter emits the radio frequency signals for controlling an output image.

3. The three-dimensional input device as claimed in claim 2, wherein when simultaneously pressing the function key and moving the cursor control unit rightward and leftward, the output image is moved rightward and leftward.

4. The three-dimensional input device as claimed in claim 2, wherein when simultaneously pressing the function key and moving the cursor control unit upward and downward, the output image is moved upward and downward.

5. The three-dimensional input device as claimed in claim 2, wherein when simultaneously pressing the function key and moving the cursor control unit forward and backward, the output image is enlarged and reduced.

6. The three-dimensional input device as claimed in claim 2, wherein when simultaneously pressing the function key and moving the cursor control clockwise, the output image is fast-forwarded.

7. The three-dimensional input device as claimed in claim 2, wherein when simultaneously pressing the function key and moving the cursor control anticlockwise, the output image is rewinded.

8. The three-dimensional input device as claimed in claim 2, wherein the cursor control unit further comprises a menu key, and when the menu key is pressed, the radio frequency emitter emits the radio frequency signals to the radio frequency receiving unit for controlling a menu image of a program of the output image or a menu image of a quick-link.

9. An electronic apparatus, comprising:
a display; and
a three-dimensional input device, comprising:
an infrared ray emitting/receiving unit, electrically connected to the display and comprising an infrared ray emitter and an infrared ray receiver;
a cursor control unit, comprising a reflective material and a radio frequency emitter; and
a radio frequency receiving unit, electrically connected to the display;
wherein the reflective material reflects infrared ray signals emitted by the infrared ray emitter, the infrared ray signals are reflected to the infrared ray receiver, and the infrared ray receiver transmits the infrared ray signals to the electric apparatus; and
the radio frequency emitter emits radio frequency signals to the radio frequency receiving unit, and the radio frequency signals are transmitted to the electronic apparatus by the radio frequency receiving unit.

10. The electronic apparatus as claimed in claim 9, wherein the cursor control unit further comprises a function key and the display outputs an output image, and when the function key is pressed, the radio frequency emitter emits the radio frequency signals for controlling the output image.

11. The electronic apparatus as claimed in claim 10, wherein when simultaneously pressing the function key and moving the cursor control unit rightward and leftward, the output image is moved rightward and leftward.

12. The electronic apparatus as claimed in claim 10, wherein when simultaneously pressing the function key and moving the cursor control unit upward and downward, the output image is moved upward and downward.

13. The electronic apparatus as claimed in claim 10, wherein when simultaneously pressing the function key and moving the cursor control unit forward and backward, the output image is enlarged and reduced.

14. The electronic apparatus as claimed in claim 10, wherein when simultaneously pressing the function key and moving the cursor control clockwise, the output image is fast-forwarded.

15. The electronic apparatus as claimed in claim 10, wherein when simultaneously pressing the function key and moving the cursor control anticlockwise, the output image is rewinded.

16. The electronic apparatus as claimed in claim 10, wherein the cursor control unit further comprises a menu key, and when the menu key is pressed, the radio frequency emitter emits the radio frequency signals to the radio frequency receiving unit for controlling a menu image of a program of the output image or a menu image of a quick-link.
